(19) United States
(12) Patent Application Publication
(10) Pub. No.: US 2017/0361891 A1
(43) Pub. Date: Dec. 21, 2017

(54) POWER ESTIMATION FROM SENSOR READINGS FOR CYCLING

(71) Applicant: REFACTOR FITNESS INC., Irvine, CA (US)

(72) Inventor: JEFFREY CROWELL, Irvine, CA (US)

(73) Assignee: REFACTOR FITNESS INC., Irvine, CA (US)

(21) Appl. No.: 15/483,488

(22) Filed: Apr. 10, 2017

Related U.S. Application Data
(63) Continuation-in-part of application No. 15/182,874, filed on Jun. 15, 2016.

(51) Int. Cl. B62J 99/00; G01L 5/13; G01L 3/24; G01S 19/19

(52) U.S. Cl. CPC B62J 99/00; G01S 19/19; G01L 5/13; G01L 3/24; B62J 2099/0026; B62J 2099/002; B62J 2099/0013

(57) ABSTRACT

A sports-related measurement system that can include a forward facing camera, a global positioning satellite receiver, and the necessary data collection and processing capabilities to calculate the aerodynamic drag and cyclist applied power of a moving object, such as a bicycle. The data collected can include altitude, air pressure, air moisture content, temperature, and the like. The system can include a display for presenting data to the user and may also include memory for storage of data, photos, video, and the like. In some embodiments, the system may be configured as a bicycle computer adapted to mount on a bicycle.

### CROSS-REFERENCE TO RELATED APPLICATIONS

This application is a continuation-in-part of U.S. patent application Ser. No. 15/182,874, filed Jun. 15, 2016, currently pending, the contents of which are herein incorporated by reference.

### BACKGROUND OF THE INVENTION

### 1. Field of the Invention

One or more embodiments of the invention relates generally to sports-related measurement systems. More particularly, the invention relates to measurement systems, suitable for use in sports, such as cycling, that include one or more of a forward facing camera, a global positioning satellite (GPS), and components, such as a hygrometer, a thermometer and a barometric altimeter, for determining aerodynamic drag. Embodiments of the present invention further provide methods for estimating power from readings taken from measurement systems.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Sports-related measurement systems have grown dramatically in sophistication over the years. With respect to bicycling, such systems have evolved from basic cable-driven speedometers, and the like, to modern electronic units capable of monitoring and displaying a number of performance characteristics.

Often, such electronic units are called bicycle computers, which, for example, track and electronically display speed, distance, and so forth. Such bicycle computers are now common in the art. Some conventional bicycle computers include a handlebar-mounted display unit to which a wheel and crank sensor are communicatively interfaced, affording the calculation of running data such as speed, distance, average speed, maximum speed and so forth, based upon electrical pulses received from the wheel and crank sensors. Other systems include a display having an analog scale field to display traveling speed and pedaling speed on a momentary, more readable basis along with a sensor associated with wheel rotation, and an additional sensor associated with pedal speed to determine cadence. In addition to the devices just described, others exist, both in patent literature and as commercially available products.

Despite the various speed, distance and cadence functions available through existing cycle-mounted computers, none of the earlier designs receive geographical coordinates through, for example, a global positioning satellite (GPS) receiver. Although a variety of vehicle-oriented tracking and mapping systems do exist which include GPS capabilities, few originally incorporated a GPS receiver with a bicycle computer. The inclusion of such a capability within a bicycle computer provides a number of unique advantages, for example, by utilizing an additional satellite to obtain altitude as well as longitude/latitude coordinates, the cyclist may be provided with elevation as well as geographic location information, which may be particularly useful in determining performance, endurance, and other characteristics. Moreover, by obtaining and storing position and/or altitude information, these characteristics may be tracked in terms of location and/or altitude, enabling the cyclist to visualize speed, cadence and other external and/or physiological characteristics as a function of geographical position, further allowing performance attributes to be tracked and plotted, for example, on an external personal computer.

As technology advances, more functionalities are being integrated into sports-related electronic devices. For example, some action cameras can capture photos and/or videos while also recording data from sensors within the camera for speed, altitude, G-force and GPS position.

However, while technology has advanced the features of such sports-related electronic devices, few advances have focused on improving the data obtained therefrom.

At racing speeds 80-90% of a cyclist's spent overcoming aerodynamic drag. Approximately 70-80% of that drag is caused not by the bike, but by the rider. It is clear that rider position has a huge effect on potential speed.

A cyclist's aerodynamic drag is a critical factor in the speed one can achieve at a given level of power output and therefore a given level of fitness. New users of cycling power models frequently observe that all of the parameters to a power or speed model—weight, gradient, wind speed, air pressure, temperature, and the like—are relatively easy to find, but that the aerodynamic drag (CdA) parameter is not so easy. With a bit of experimentation, it becomes apparent that CdA has the greatest effect on the “speed given power” or “power given speed” output from the model on all but the hilliest courses and that minimizing drag is key to faster cycling. In fact, the ratio of a rider's power to CdA is probably far more important that the often quoted “watts per kilo” measure. However, conventional bicycle computers provide equipment and processing to determine aerodynamic drag.

In view of the foregoing, there is a need for sports-related electronic devices, such as bicycle computers, that provide not only multiple features, but also improves upon the data obtained therefrom.

### SUMMARY OF THE INVENTION

Embodiments of the present invention provide an integrated electronic apparatus comprising an altimeter; a hygrometer; a thermometer; a wireless chip configured to send and receive data; and a processor programmed to calculate cyclist applied power during movement of a device on which the apparatus is mounted.

Embodiments of the present invention further provide an integrated electronic apparatus comprising an altimeter; a hygrometer; a thermometer; a wireless chip configured to at least receive data from an external sensor; a processor programmed to calculate cyclist applied power during movement of a device on which the apparatus is mounted; a global positioning satellite receiver for generating location data; a display configured on one side of the apparatus; and a forward facing camera adapted to capture data.

Embodiments of the present invention also provide a bicycle computer comprising an altimeter; a hygrometer; a thermometer; a wireless chip configured to at least receive data from at least one external sensor, wherein the at least one external sensor includes a power meter; a processor programmed to calculate cyclist applied power during movement of a bicycle on which the apparatus is mounted; a global positioning satellite receiver for generating location data; a display configured on one side of the apparatus; a forward facing camera adapted to capture data; a mount disposed on a side opposite the display; and memory for storing and retrieving data.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a front perspective view of a sports-related electronic device according to an exemplary embodiment of the present invention;

FIG. 2 illustrates another front perspective view of the sports-related electronic device of FIG. 1;

FIG. 3 illustrates an end view of the sports-related electronic device of FIG. 1;

FIG. 4 illustrates another front perspective view of the sports-related electronic device of FIG. 1;

FIG. 5 illustrates a back view of the sports-related electronic device of FIG. 1;

FIG. 6 illustrates a block diagram illustrating at least some of the modules of the sports-related electronic device of FIG. 1; and

FIG. 7 illustrates various forces acting on a bicycle on an incline, where these forces can be used to determine cyclist applied power to produce a measured speed according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units. The sports-related electronic device, according to aspects of the present invention, may be considered to fit within this definition of a “computer”.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Aspects of the present invention are described below with reference to block diagrams of apparatus (systems) according to embodiments of the invention. It will be understood that some or all blocks of the block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the following specification and claims. Each block in the block diagram may represent a module, segment, or portion of code, which comprises one or more features of the present invention.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Broadly, embodiments of the present invention provide a sports-related measurement system that can include a forward facing camera, a global positioning satellite receiver, and the necessary data collection and processing capabilities to calculate the cyclist applied power of a moving object. The data collected can include altitude, air pressure, air moisture content, temperature, and the like. The system can include a display for presenting data to the user and may also include memory for storage of data, photos, video, and the like. In some embodiments, the system may be configured as a bicycle computer adapted to mount on a bicycle.

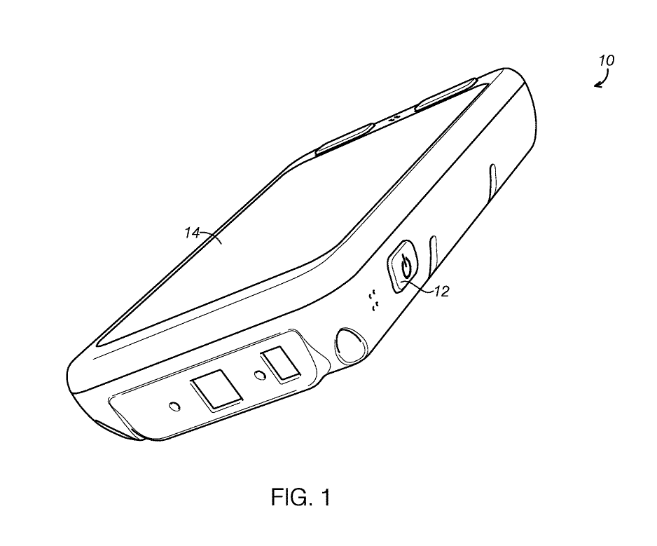

Referring to FIGS. 1 through 6, an electronic device 10, also referred to as a sports-related electronic device 10, may be configured for use in various applications. While the description below refers specifically to a bicycle computer application, it should be understood that aspects of the present invention may be useful in other applications and in other fields.

As shown in FIG. 1, in its most basic form, the electronic device 10 can include a power on/off button 12 and a display screen 14. In some embodiments, the electronic device 10, including all buttons, ports, and the like, are designed to be water resistant. Such a designs allows the user to utilize the device 10 while, for example, cycling in inclement weather.

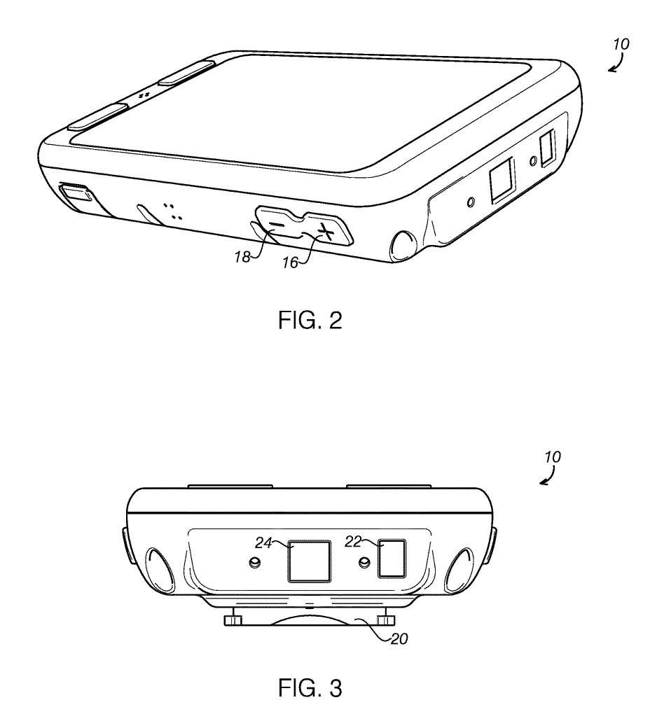

FIG. 2 illustrates exemplary control buttons, such as a plus button 16 and a minus button 18. These buttons may be useful to control various features of the device 10, as discussed in greater detail below.

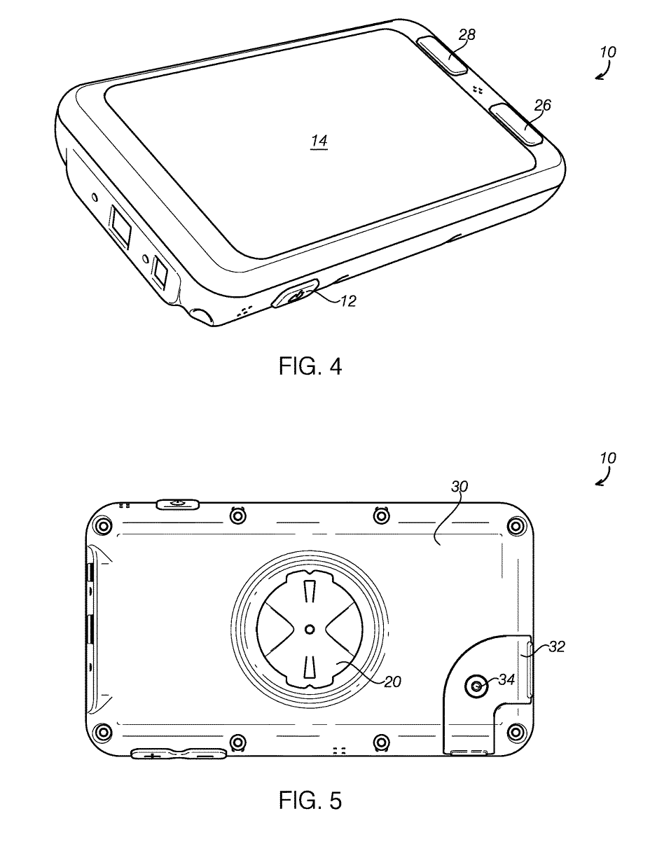

FIG. 3 illustrates various ports 22, 24 that may be accessible from an exterior of the device 10. These ports 22, 24 may include communication ports, charging ports, accessory ports, and the like. For example, the device 10 may be powered by an internal, rechargeable battery. One of the ports 22, 24 may be used to provide power to recharge the battery as needed. In some embodiments, one of the ports 22, 24 may be used to establish a data connection to transmit data to an external computer, data storage, or the like. In some embodiments, the device 10 can include a wireless communication module (not shown) that may be used to communicate with an external device.

FIG. 4 illustrates additional control buttons 26, 28 that may be disposed on a front surface of the device, adjacent the display 14. These control buttons 26, 28 may be useful to control various features of the device 10, as discussed in greater detail below.

FIG. 5 illustrates a back surface 30 of the device 10. A mounting member 20 may be disposed on the back surface 30. While shown centered upon the back surface 30, the mounting member 20 may be disposed at other locations on the back surface 30, depending on mounting method and specific application. While a specific design for the mounting member 20 is shown in FIG. 5, other mounts and mounting members may be utilized according to desired application and positioning.

In some embodiments a camera 34 may be disposed on the back surface 30 of the device. As discussed in greater detail below, the camera 34 may be used to capture a forward view while the device 10 is used. Depending on mounting position, the camera 34 may be positioned along one side, or upon a top edge of the device 10, provided that such positioning provides a forward view. In some embodiments, the device 10 may include more than one camera 34, where the user can choose from which camera to take input.

A cover 32 may be disposed adjacent to the camera 34 for allowing removable accessory devices to be attached. For example, the cover 32 can be removed to allow mounting of a wide angle lens or other like camera accessories.

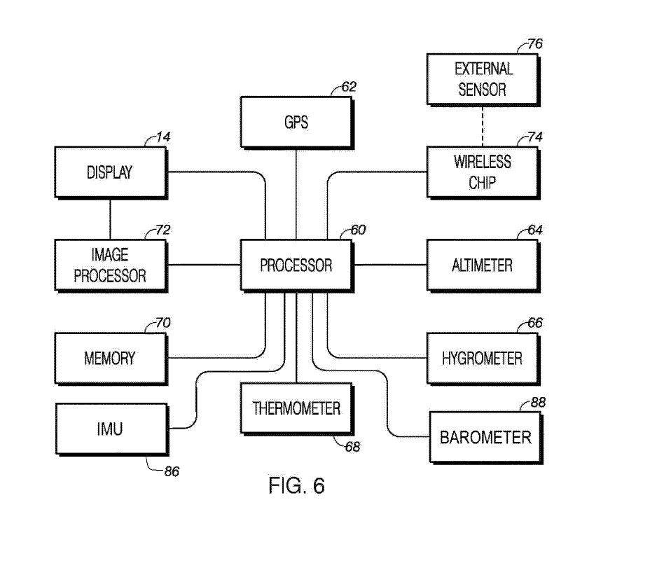

Referring now to FIG. 6, the device 10 can include various modules for performing various tasks. Some of these modules are shown in FIG. 6. The various modules shown here should not be interpreted to refer to all modules or provide all functionalities of the device 10.

The device 10 can include a processor 60 for receiving data from various modules. The processor 60 may also receive user input, process data and provide an output on the display 14. The processor 60 can also receive input from, for example, the display 14 (when the display 14 is a touch screen), or from the buttons 16, 18, 26, 28 to provide a desired feature or function. For example, when a map is displayed on the display 14, the user may use the plus button 16 and the minus button 18 to zoom the map on the display 14. An image processor 72 may be utilized in conjunction with the display 14 for controlling how the data that is shown on the display 14.

The processor 60 may receive data from various modules, such as a GPS module 62, an altimeter 64, a hygrometer 66 and a thermometer 68, for example. In some embodiments, the altimeter 64 of hygrometer 66 may be configured to measure air pressure as well as altitude and air moisture content, for example, altimeter 64 may be a barometric altimeter. In other embodiments, a separate module may be utilized to measure air pressure. The processor 60 may also receive data from the user, either by direct entry, or when the device 10 is connected, either wired, or wirelessly, to a separate computing device. This data may include user information, bicycle weight, bicycle rolling resistance, and the like.

The device 10 can further include a wireless chip 74 configured to send and/or receive data. In some embodiments, an external bike sensor 76 may send data to the wireless chip 74, which may communicate such data to the processor 60. In some embodiments, the external bike sensor 76 can include a power meter, for example. The wireless chip 74 may communicate via various protocols, including, for example BTLE (Bluetooth Low Energy) and ANT+ communication protocols.

In some embodiments, memory 70 may be included to store information. This information can include, for example, data captured by the camera 34, including photos, video of the like, speed information received from a speedometer (not shown) or from the GPS 62, temperature information received from the thermometer 68, altitude information received from the altimeter 64 or the GPS 62, humidity information from the hygrometer 66, and the like.

In some embodiments, the processor 60 may receive information from the altimeter 64, hygrometer 66, thermometer 68 and external sensor 76 (via wireless chip 74) to calculate aerodynamic drag and cyclist applied power (P(cyclist)) and display such information on the display. The data from each of these components can be put into a calculation to isolate the CdR (rolling resistance) and provide the CdA (aero dynamic resistance). Various methods may be used to calculate the aerodynamic drag and the cyclist applied power within the device 10. As non-limiting examples, the processor may use the obtained data to obtain aerodynamic drag via the Chung Method or the Martin Method, for example. The present invention may use alternate methods to calculate aerodynamic drag and cyclist applied power, as may be understood by one having ordinary skill in the art. For example, the present invention may utilize a modified Chung Method, where, instead of riding a known loop (or up and down in a valley), because the device 10 includes an altimeter, one does not necessarily need to ride with a zero change of altitude, as is required by the Chung method, for example.

Currently, a rider looking to determine their aerodynamic drag must obtain power data, transfer this data to a separate computer, access a software module (such as Golden Cheetah shareware), input air temperature and pressure data into one module of the software module, access a further software module to perform an analysis to calculate aerodynamic drag. With the present invention, however, by having modules included to determine temperature, humidity, air pressure, altitude, and the like, the aerodynamic drag and cyclist applied power can be calculated automatically and shown on the display. Thus, if a user decided to change padding, for example, the user can simply ride a course with and without the padding and the device 10 can determine aerodynamic drag and cyclist applied power for each scenario.

In some embodiments, the display may allow a user to save data, such as aerodynamic drag, cyclist applied power, and the like, for a certain course or for a certain ride. A user can compare this data to help improve rider position, the use of accessories, and the like.

As discussed above, the camera 34 may be a forward facing camera. This camera may be used to visualize a forward view of a cyclist and act as an accident detection/avoidance system, where a user may be provided with advance warning of something in their path a given distance forward of their direction of travel. This feature may include other sensors, or the like, to provide a complete accident avoidance system. The processor 60 may receive signals from the camera 34, as well as other sensors, and determine whether an alert should be provided to the rider. The alert may be audio, visual, a combination thereof, or the like.

A noted above, the buttons 16, 18, 26, 28 may provide map zooming features as well as other features of the device. For example, a user may be able to control what items are displayed on the screen, start and stop stopwatch features, add marks on the map in the GPS system, calibrate weather data, such as temperature, humidity, air pressure, and the like. In some embodiments, such as when a touch screen is used for user input, some or all of the buttons 16, 18, 26, 28 may be eliminated from the device 10.

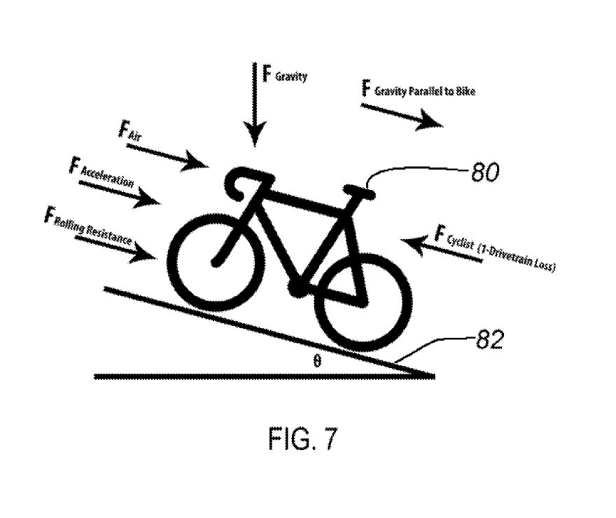

Referring now to FIG. 7, various forces acting on a bicycle 80 are shown with the bicycle is advancing an incline 82. Knowledge of these forces, as well as the calculation of aerodynamic drag, as discussed above, can permit the processor 60 to calculate the total power produced by a cyclist while riding. In general terms, this determination is made from several components, including the power (P(rolling resistance)) produced to overcome the rolling resistance of forward motion (F_{Rolling Resistance}), the power (P(wind)) produced to overcome wind resistance (F_{Air}), the power (P(gravity)) produced to overcome the pull of gravity (in the case of climbing hills) (F_{Gravity}) and the power (P(acceleration)) produced to accelerate from one speed to another (F_{Acceleration}).

The total power produced, P(total) is the sum of all four power components. In other words,

P(total)=P(rolling resistance)+P(wind)+P(gravity)+P(acceleration).

However, it should be understood that P(total) is the power applied at the back wheel, which will be less than the power applied at the cranks by the cyclist because of drivetrain loss. In other words, the cyclist applied power P(cyclist) is

P(cyclist)=P(total)/(1−(Drivetrain Loss %/100)).

The power required to overcome rolling resistance, P(rolling resistance), can be described by the formula

P=Cᵣᵣ×N×v,

where

P is the power required,

Cᵣᵣ is the rolling resistance coefficient, as discussed above,

N is the normal force of the bike and the rider against gravity, and

v is the rider velocity.

The power required to overcome wind resistance (drag), P(wind), can be described by the formula

P=0.5×ρ×v²×C_{d}×A,

where

P is the power required,

ρ is the density of air,

v is the rider velocity, relative to the wind,

C_{d} is the drag coefficient, as discussed above, and

A is the surface area of the rider facing the wind.

The power required to overcome the pull of gravity, P(gravity), while riding up an incline of an angle θ can be described by the formula

P=m×g×sin(arctan(θ))×v,

where

P is the power required,

m is the mass of the rider and the bicycle,

g is the gravitational constant (9.8)

θ is the grade or slope of the incline, and

v is the rider velocity.

The power required to accelerate from one speed to another, P(acceleration), within a ride sampling window can be described by the formula

P=m×a×v,

where

P is the power required,

m is the mass of the rider and bicycle,

a is the acceleration between one's starting speed and one's ending speed within the sampling window, and

v is the average velocity for the sampling window.

Referring now to FIGS. 6 and 7, the incline or grade can be determined from the inertial measurement unit (IMU) 86. Air density can be calculated from readings from the hydrometer 66, thermometer 68 and barometer 88. Dew point can be calculated from the relative humidity taken from the hygrometer reading using methods known in the art. Velocity can be read from either the GPS 62, of, if available, an external speed sensor connected via the wireless chip 74. Acceleration can be calculated as the difference in speed in the sampling interval, and corrected against an accelerometer.

Rolling resistance (Crr) can be estimated, as discussed above, from the type of tire and surface, or alternatively, calculated with trial runs to isolate Cd and Crr using, for example, the Virtual Elevation method.

Wind can be estimated as the velocity of the cyclist, or if available, read from an external wind sensor connected via the wireless chip 74. If an external sensor is unavailable and weather service is available, wind can be estimated from reported local weather reports. Reading the actual wind speed relative to the cyclist will make the algorithm greatly more accurate in most conditions. Furthermore, a wind sensor (anemometer) combined with a power meter allows for rapid feedback to changes in CdA, rather than the virtual elevation method which requires a field test loop to be performed.

Cd and A can be estimated from anthropometric data, for initial estimates, or alternatively, calculated from the Virtual Elevation method, as CdA, as described above.

While the drawings show a particular design and layout for the buttons, ports, display, mount, and the like, the device 10 can be laid out in various configurations provided that the functions herein described and claimed are present in the device 10. For example, in some embodiments, the device 10 may include modules to determine aerodynamic drag and cyclist applied power and may exclude various other features. In other embodiments, the device 10 may be a complete bicycle computer, including a forward facing camera, GPS features, and aerodynamic drag and cyclist applied power calculation features.

While the above described device 10 focuses on use as a bicycle computer, the device 10 may be adapted for use in other fields. For example, the device 10 calculates air density as part of the cyclist applied power determination and, more particularly, in the power required to overcome wind resistance (drag) calculation, as discussed below. The air density data may be useful to equilibrate performance data on vehicles, for example. In other embodiments, the device 10 may be useful for comparing aerodynamic drag and/or cyclist applied power on other vehicles. For example, a truck driver could determine aerodynamic drag and/or cyclist applied power of their vehicle with and without various accessories, thereby optimizing their fuel economy.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The definitions of the words or elements of the following claims are defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. An integrated electronic apparatus comprising:
a plurality of sensors including an altimeter, a hygrometer and a thermometer;
a wireless chip configured to send and receive data; and
a processor programmed to calculate cyclist applied power during movement of a device on which the apparatus is mounted, wherein cyclist applied power is calculated from sensor inputs of temperature, humidity, air pressure and elevation received by the processor from the plurality of sensors.

2. The integrated electronic apparatus of claim 1, wherein the processor receives information from the altimeter, the hygrometer, the thermometer and the wireless chip, wherein the wireless chip receives data from an external bike sensor.

3. The integrated electronic apparatus of claim 1, further comprising a global positioning satellite receiver for generating location data.

4. The integrated electronic apparatus of claim 1, further comprising a display configured on one side of the apparatus.

5. The integrated electronic apparatus of claim 1, further comprising a camera adapted to capture data.

6. The integrated electronic apparatus of claim 5, wherein the camera faces forward when the apparatus is mounted on the device.

7. The integrated electronic apparatus of claim 1, further comprising memory for storing and retrieving data.

8. The integrated electronic apparatus of claim 1, further comprising an accessory mount configured to attach a removable accessory on the apparatus.

9. The integrated electronic apparatus of claim 4, further comprising a mount disposed on a side opposite the display.

10. The integrated electronic apparatus of claim 1, wherein the apparatus is configured to mount on a bicycle and determine the aerodynamic drag of a user riding the bicycle.

11. An integrated electronic apparatus comprising:
a plurality of sensors including an altimeter, a hygrometer and a thermometer;
a wireless chip configured to at least receive data from an external sensor;
a processor programmed to calculate aerodynamic drag and cyclist applied power during movement of a device on which the apparatus is mounted, wherein cyclist applied power is calculated from sensor inputs of temperature, humidity, air pressure and elevation received by the processor from the plurality of sensors;
a global positioning satellite receiver for generating location data;
a display configured on one side of the apparatus; and
a forward facing camera adapted to capture data.

12. The integrated electronic apparatus of claim 11, further comprising memory for storing and retrieving data.

13. The integrated electronic apparatus of claim 11, further comprising an accessory mount configured to attach a removable accessory on the apparatus.

14. The integrated electronic apparatus of claim 11, further comprising a mount disposed on a side opposite the display.

15. The integrated electronic apparatus of claim 11, wherein the apparatus is configured to mount on a bicycle and determine the aerodynamic drag and cyclist applied power of a user riding the bicycle.

16. A bicycle computer comprising:
a plurality of sensors including an altimeter, a hygrometer and a thermometer;
a wireless chip configured to at least receive data from at least one external sensor, wherein the at least one external sensor includes a power meter;
a processor programmed to calculate aerodynamic drag and cyclist applied power during movement of a bicycle on which the apparatus is mounted, wherein cyclist applied power is calculated from sensor inputs of temperature, humidity, air pressure and elevation received by the processor from the plurality of sensors;
a global positioning satellite receiver for generating location data;
a display configured on one side of the apparatus;
a forward facing camera adapted to capture data;
a mount disposed on a side opposite the display; and
memory for storing and retrieving data.

17. The bicycle computer of claim 16, further comprising an accessory mount configured to attach a removable accessory on the apparatus.
